(19) United States
(12) Patent Application Publication
(10) Pub. No.: US 2004/0118982 A1
(43) Pub. Date: Jun. 24, 2004

(54) Organizer for medical tubes and cables

(76) Inventors: D. Kay Shillings, Amarillo, TX (US); D?apos;Ann Boyd, Amarillo, TX (US)

Correspondence Address: BRACEWELL & PATTERSON, LLP, INTELLECTUAL PROPERTY LAW, P.O. BOX 61389, HOUSTON, TX, 77208-1389, US

(21) Appl. No.: 10/323,270

(22) Filed: Dec. 20, 2002

(51) Int. Cl. F16L 3/22

(52) U.S. Cl. 248/68.1

(57) ABSTRACT

Apparatus for organizing medical lines so as to facilitate identification and prevent entanglement and dislodgement of the lines includes a rigid elongated base panel and an upwardly directed securing panel. Mounting features located beneath the base panel enable the apparatus to be quickly and removably attached to the rail of a hospital bed. A series of slots in the securing panel extend toward the base panel and terminate in confining apertures having dimensions larger than the width of the associated slot. The apparatus permits transverse insertion of a medical line into a slot and positioning in a confining aperture, thereby allowing longitudinal and limited lateral movement of the line while preventing entanglement with adjacent lines.

### BACKGROUND OF THE INVENTION

1. Field of the Invention

This invention relates to apparatus for neatly organizing medical lines which administer to a patient, and more particularly concerns apparatus which functionally secures a plurality of flexible cables and fluid-carrying tubes interactive with a patient in a hospital bed.

2. Description of the Prior Art

The subject matter of this invention will be discussed primarily in conjunction with flexible lines in the form of fluid-conducting tubes that are commonly used within the medical profession. However, it is considered to be within the scope of this invention that the apparatus of the invention could be utilized in conjunction with lines other than tubes, such as for example electrical and fiber optic cables employed for monitoring or diagnostic purposes.

During the course of medical procedures, a human patient is often infused simultaneously with a plurality of different medications and fluids. Those medications and fluids are fed into the patient through tubes. Additionally, catheters are frequently utilized to monitor body functions. Many of these catheter, fluid-conducting tubes and monitoring lines are placed on the patient prior to when the patient is transported from a surgery area to a convalescing area. These different lines have a tendency to become entangled, making it difficult for attending physicians and nurses to ascertain which line is being utilized for which purpose. At times certain medications are injected into a fluid line. Extreme care has to be exercised to make sure that the right medicine is being injected into the correct line. This problem of confusing lines and catheters entering a patient's body is accentuated under emergency conditions. The foregoing problems increase the risk of patient injury by either infusing medicine or blood at the wrong entry site, or by failure to infuse needed medications.

This entanglement of the different lines is exceedingly common in the hospital room while the patient is recovering from a surgical operation. The entanglement is caused primarily by the patient moving around in either a conscious or unconscious condition. Some means is therefore needed in a hospital room for organizing the various medical lines servicing a bedridden patient, said organization facilitating the location and identification of each line and preventing their entanglement and dislodgement.

Devices for organizing medical lines that service a patient in a hospital bed are disclosed in U.S. Pat. Nos. 5,334,186; 5,336,179; 5,427,338; 5,624,403; 5,876,371 and elsewhere.

Most earlier organizer devices restrict movement of the lines they secure. Such restriction enables tensile stress to be placed upon a line with movement of the patient. The resultant stress can cause the medical line to separate from its interaction with the patient or with a monitoring instrument.

Earlier medical line organizers may also be incompatible with typical hospital beds or may be difficult to attach thereto. The individual lines may not be easily engageable by the organizer, and inadequate means are provided for the identification of each line.

It is accordingly an object of the present invention to provide apparatus for organizing medical lines interactive with a bedridden patient.

It is another object of this invention to provide an organizer apparatus as in the foregoing object adapted to separately constrain a number of medical lines without preventing axial or lateral motion thereof.

It is a further object of the present invention to provide an organizer apparatus of the aforesaid nature which is easily securable to a hospital bed, and readily accepts said medical lines.

It is yet another object of this invention to provide an organizer apparatus of the aforesaid nature which readily permits association of identifying indicia with each of said medical lines.

It is a still further object of the present invention to provide an organizer apparatus of the aforesaid nature of durable, compact construction amenable to sterilization treatment.

It is an additional object of this invention to provide an organizer apparatus of simple construction amenable to sufficiently low cost manufacture as to justify disposal following limited use.

These objects and other objects and advantages of the invention will be apparent from the following description.

### SUMMARY OF THE INVENTION

The above and other beneficial objects and advantages are accomplished in accordance with the present invention by an organizer apparatus for mounting upon a rail of a hospital bed for receiving flexible medical lines, said apparatus comprising:

a) a rigid base panel of elongated rectangular contour bounded in part by a flat upper surface and opposed lower surface,

b) mounting means associated with said lower surface for the purpose of releasibly engaging a rail of said hospital bed, and

c) a securing panel orthogonally emergent from said upper surface and terminating in a distal extremity parallel to said upper surface, and having a series of spaced apart slots which open upon said distal extremity and terminate in a confining aperture within said securing panel and dimensioned larger than the width of the associated slot, whereby

d) a flexible medical line can be laterally inserted through a slot and caused to reside within an associated confining aperture which permits axial and lateral sliding movement of the line, and said flat upper surface permits placement of indicia to identify each confined line.

### BRIEF DESCRIPTION OF THE DRAWING

For a fuller understanding of the nature and objects of the invention, reference should be had to the following detailed description taken in connection with the accompanying drawing forming a part of this specification and in which similar numerals of reference indicate corresponding parts in all the figures of the drawing:

FIG. 1 is a top and side perspective view of an embodiment of the organizer apparatus of the present invention.

FIG. 2 is a top view of the embodiment of FIG. 1.

FIG. 3 is a side view of the embodiment of FIG. 1.

FIG. 4 is an end view of the embodiment of FIG. 1.

### DESCRIPTION OF THE PREFERRED EMBODIMENT

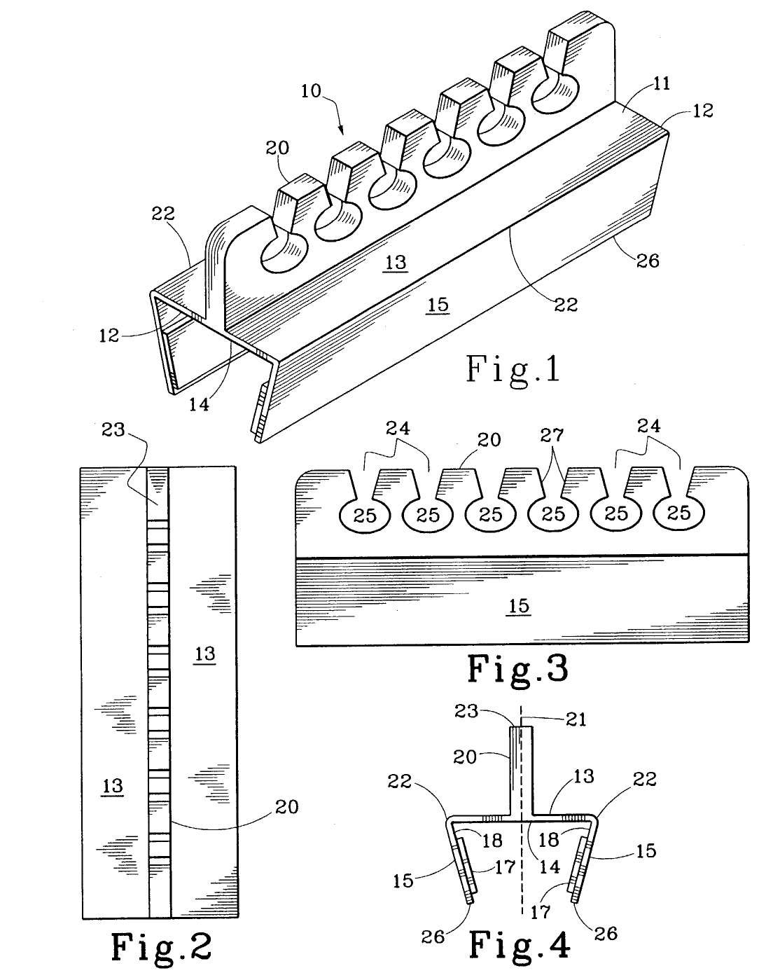

Referring now to FIGS. 1-4, an embodiment of the organizer apparatus 10 of the present invention is shown as a monolithic structure which may be fabricated of thermoplastic material by way of a molding operation or by an extrusion operation with a subsequent punching or machining step.

The organizer apparatus is shown comprised of a rigid base panel 11 of rectangular contour elongated between end extremities 12 and bounded in part by flat upper surface 13 and opposed lower surface 14. The length of said base panel, measured between said end extremities may range from about 6 to 12 inches. The width of upper surface 13, measured between opposed side edges 22 may range from about 1 to 3 inches.

Opposed side panels 15, downwardly directed from said lower surface, are spaced apart a proper distance to frictionally embrace a bed rail. Said side panels, in concert with said lower surface thereby function as mounting means which permit rapid, releasable attachment of the apparatus to a bed rail. A layer of rubbery material 17 may be adhered to the facing surfaces 18 of said side panels for the purpose of preventing slippage of the apparatus while mounted upon the bed rail. Said side panels may typically have a height of 1 to 3 inches, as measured between upper surface 13 and the lower edge 26 of said side panel.

In the embodiment exemplified in FIGS. 1-4, side panels 15 are downwardly convergent. Such configuration enables the side panels to operate resiliently to embrace the bed rail. The diameter of most hospital bed rails is 1.378 inches. By causing the lowermost edges 26 of said side panels to be spaced slightly less than 1.378 inches apart, the side panels function as a spring-like mounting clip which receives and secures a bed rail.

A securing panel 20 is orthogonally emergent from upper surface 13 in parallel relationship to side edges 22. Said securing panel is preferably centered upon upper surface 13, thereby causing the apparatus to have a longitudinal plane of symmetry 21. Securing panel 20 is upwardly terminated by straight distal extremity surface 23 parallel to upper surface 13. Said distal surface has a series of spaced apart slots 24 elongated toward said upper surface and terminating in a confining aperture 25 within said securing panel. Slots 24 preferably have a widened upper extremity in the form of an upwardly flared configuration 27 which facilitates insertion of a line laterally, namely in a direction transverse to the direction of elongation of said line.

Slots 24 have a width between about 3 and 10 millimeters at their narrowest point, and can be varied within the organizer apparatus. The confining aperture, as measured in both horizontal and vertical directions relative to upper surface 13, is larger than the narrowest width of associated slot 24. Confining apertures 25 may typically have a circular, oval or rectangular configuration. It is important that said configuration be horizontally elongated, namely elongated upon an axis parallel to upper surface 13. In some embodiments, securing panel 20 may be fabricated of a resilient or rubbery material, and attached to base panel 11.

By virtue of the aforesaid construction, the organizer apparatus can accommodate medical lines in an orderly manner. Said medical lines may be tubes that convey liquids or gasses to or from the patient, or may be electrical or fiber optic cables utilized to monitor or otherwise administer to the patient's condition or needs. Such medical lines, when laterally inserted through a slot, are caused to reside within an associated confining aperture in a manner which permits axial and lateral sliding movement of the line. Flat upper surface 13 permits placement of indicia to identify such confined line. Suitable indicia include self-sticking labels and pen markings. The indicia may also include instructional information. On/off control valves, clamps, hypodermics or other operational features may be associated with appropriate lines adjacent the organizer apparatus.

While particular examples of the present invention have been shown and described, it is apparent that changes and modifications may be made therein without departing from the invention in its broadest aspects. The aim of the appended claims, therefore, is to cover all such changes and modifications as fall within the true spirit and scope of the invention.

Having thus described our invention, what is claimed is:

1) An organizer apparatus for mounting upon a rail of a hospital bed for receiving flexible medical lines, said apparatus comprising:
a) a rigid base panel of elongated rectangular contour bounded in part by a flat upper surface and opposed lower surface,
b) mounting means associated with said lower surface for the purpose of releasibly engaging a rail of said hospital bed, and
c) a securing panel orthogonally emergent from said upper surface and terminating in a distal extremity parallel to said upper surface, and having a series of spaced apart slots which open upon said distal extremity and terminate in a confining aperture within said securing panel and dimensioned larger than the width of the associated slot, whereby
d) a flexible medical line can be laterally inserted through a slot and caused to reside within an associated confining aperture which permits axial and lateral sliding movement of the line, and said flat upper surface permits placement of indicia to identify each confined line.

2) The organizer apparatus of claim 1 wherein said mounting means is comprised of opposed side panels downwardly directed from said lower surface and having facing surfaces spaced apart a proper distance to frictionally embrace a bed rail, said side panels acting in concert with the lower surface of said base panel.

3) The organizer apparatus of claim 2 wherein said mounting means is provided with a layer of a rubbery material attached to said facing surfaces for the purpose of preventing slippage of the apparatus while mounted upon said bed rail.

4) The organizer apparatus of claim 3 wherein said side panels are downwardly convergent, terminating in lowermost parallel edges spaced apart by a distance slightly smaller than the diameter of said bed rail.

5) The organizer apparatus of claim 4 wherein said side panels operate in a resilient manner to grip said bed rail.

6) The organizer apparatus of claim 5 wherein said side panels have a height between 1 and 3 inches, as measured between the upper surface of said base panel and said lowermost edges.

7) The organizer apparatus of claim 2 wherein said slots have a widened upper extremity which opens upon said distal extremity and facilitates transverse insertion of a medical line.

8) The organizer apparatus of claim 2 wherein said confining apertures are elongated in a direction parallel to said upper surface of said base panel.

9) The organizer apparatus of claim 8 wherein said confining apertures have an oval shaped configuration.
